(19) United States
(12) Patent Application Publication
(10) Pub. No.: US 2020/0264443 A1
(43) Pub. Date: Aug. 20, 2020

(54) DIFFRACTIVE OPTICAL ELEMENT

(71) Applicant: AGC Inc., Chiyoda-ku (JP)

(72) Inventors: Kensuke ONO, Chiyoda-ku (JP); Ryota MURAKAMI, Koriyama-shi (JP)

(73) Assignee: AGC Inc., Chiyoda-ku (JP)

(21) Appl. No.: 16/845,250

(22) Filed: Apr. 10, 2020

Related U.S. Application Data
(63) Continuation of application No. PCT/JP2018/039755, filed on Oct. 25, 2018.

(30) Foreign Application Priority Data
Nov. 8, 2017 (JP) 2017-215510

(51) Int. Cl. G02B 27/42; G02B 5/18

(52) U.S. Cl. CPC G02B 27/4244; G02B 5/1861; G02B 5/1866; G02B 27/4261

(57) ABSTRACT

To provide a diffractive optical element which is thin and is capable of emitting light in a wide range while further reducing zeroth order light.

The diffractive optical element of the present invention comprises a substrate, a convexo-concave portion formed on one surface of the substrate and having a predetermined diffraction function to incident light, and an antireflection layer formed between the substrate and the convexo-concave portion, wherein the difference in the refractive index in a wavelength band of the incident light between a first medium constituting convex portions of the convexo-concave portion and a second medium constituting concave portions of the convexo-concave portion is at least 0.70, and when the incident light enters from a normal direction of the substrate, an emergent angle range which is an angle range representing spread of a light pattern formed by the diffracted light emerging from the convexo-concave portion, is at least 60°.

### TECHNICAL FIELD

The present invention relates to a diffractive optical element to form light spots having a predetermined pattern.

### BACKGROUND ART

A device to measure a position, a shape, etc. of an object to be measured, by applying predetermined light to the object to be measured and detecting light scattered by the object to be measured, is available (for example, Patent Document 1). In such a measuring device, a diffractive optical element may be used to apply light having a specific pattern to the object to be measured.

For example, a diffractive optical element produced by convexo-concave processing a surface of a substrate is known. In the case of such a convexo-concave structure, light is diffracted with the desired path difference by utilizing a difference in the refractive index between a material with which the concave portion is filled (for example, air having a refractive index=1) and a material of the convex portion.

As another example of the diffractive optical element, a diffractive optical element having a structure such that a concave portion (specifically, the concave portion and the top surface of a convex portion) is filled with a refractive index material which is different from a material for the convex portion and is not air, has been known. In the above structure, the change of the diffraction efficiency due to attached substances can be suppressed, since the convexo-concave surface is not exposed. For example, Patent Document 2 discloses a diffractive optical element using another transparent material having a different refractive index to fill a convexo-concave pattern which forms two-dimensional light spots.

Here, some optical devices utilize invisible light such as near infrared light. For example, a remote sensing device used for face recognition or focusing in a camera device in a smart phone, etc., a remote sensing device connected to a game machine or the like and used for capturing motion of a user, LIDAR (light detecting and ranging) device used for detecting peripheral objects, etc. in vehicles, etc. may be mentioned.

Further, some of these optical devices require to emit light at an emergent angle which is largely different from a traveling direction of incident light. For example, it is sometimes desired to emit light in a broad angle range, e.g. at least 60°, at least 100° or at least 120° in an application of focusing for a camera device having a wide angle of field, equipped in a smart phone, etc., in an application for detecting peripheral objects such as an obstacle or fingers to be displayed on a display device having a screen adapted to a view angle of human such as a VR (virtual reality) headset.

In a case where light is emitted in a broad angle range as described above by utilizing a diffractive optical element, pitches are required to be narrow for forming a convexo-concave structure. Particularly, in a case of a convexo-concave structure having a large emergent angle range to incident light having a long wavelength such as near infrared light, convex portions tend to be higher in order to obtain the desired path difference. Here, the height of the convex portions may be read as the depth of concave portions.

If pitches of the convexo-concave portion in the diffractive optical element are made to be narrow, or the height is increased, the aspect ratio (for example, “height of convex portions/width of convex portions”) becomes thereby high. If the aspect ratio is high, the area proportion of side walls (side surfaces of convex portions) in the entire surface of the convexo-concave portion to be an interface to light traveling in the convexo-concave portion increases, which results in that the influence of reflection or the like at the side surfaces of the convex portions become large, and undesired zeroth order light may be generated. In general, it is not desired to emit intense zeroth order light for safety of eyes.

Regarding techniques to reduce zeroth order light for a diffractive optical element, for example, Patent Document 3 discloses a structure having two diffractive optical elements (DOE: diffractive optical element). In the technique disclosed in Patent Document 3, zeroth order light is reduced by a structure such that zeroth order light generated by a first diffractive optical element is diffracted by a second diffractive optical element.

### PRIOR ART DOCUMENTS

### Patent Documents

Patent Document 1: Japanese Patent No. 5174684

Patent Document 2: Japanese Patent No. 5760391

Patent Document 3: JP-A-2014-209237

### DISCLOSURE OF INVENTION

### Technical Problem

It is desired to thin a diffractive optical element for sensing to respond to a demand in view of design for hiding a sensor and a demand for thinning and downsizing an overall housing in which a sensor is equipped.

Under these circumstances, it is an object of the present invention to provide a diffractive optical element which is thin and is capable of emitting light in a wide range while further reducing zeroth order light.

### Solution to Problem

The diffractive optical element of the present invention comprises a substrate, a convexo-concave portion formed on one surface of the substrate and having a predetermined diffraction function to incident light, and an antireflection layer formed between the substrate and the convexo-concave portion, wherein the difference in the refractive index in a wavelength band of the incident light between a first medium constituting convex portions of the convexo-concave portion and a second medium constituting concave portions of the convexo-concave portion is at least 0.70, and when the incident light enters from a normal direction of the substrate, an emergent angle range which is an angle range representing spread of a light pattern formed by diffracted light emerging from the convexo-concave portion, is at least 60°.

### Advantageous Effects of Invention

According to the present invention, a diffractive optical element which is thin and is capable of emitting light in a wide range while further reducing zeroth order light, can be provided.

### BRIEF DESCRIPTION OF DRAWINGS

FIG. 1 is a schematic cross-sectional view of a diffractive optical element 10 in a first embodiment.

FIGS. 2A and 2B are schematic cross-sectional views illustrating another example of a diffractive optical element 10.

FIG. 3 is a view illustrating an example of a light pattern formed by a diffractive optical element 10.

FIGS. 4A and 4B are graphs illustrating the relation between the grating depth d and the intensity of zeroth order light.

FIG. 5 is a graph illustrating the relation between view angle θ_{d} in the diagonal direction and intensity of zeroth order light (local minimum value of zeroth order light) with respect to five different diffractive index materials.

FIGS. 6A and 6B are the relation between Δn/NA and the intensity of zeroth order light (minimum value) with respect to five different diffractive index materials.

FIG. 7 is a schematic cross-sectional view illustrating another example of a diffractive optical element 10.

FIGS. 8A and 8B are graphs illustrating results of calculation of the reflectance of an antireflection layer 14 in Ex. 1.

FIG. 9 is a graph illustrating the incident angle dependence of the reflectance of an antireflection layer 14 in Ex. 1 to light having a wavelength of 850 nm.

FIGS. 10A and 10B are graphs illustrating results of calculation of the reflectance of an inner antireflection layer 13 in Ex. 1.

FIG. 11 is a graph illustrating the incident angle dependence of the reflectance of an inner antireflection layer 13 in Ex. 1 to light having a wavelength of 850 nm.

### DESCRIPTION OF EMBODIMENTS

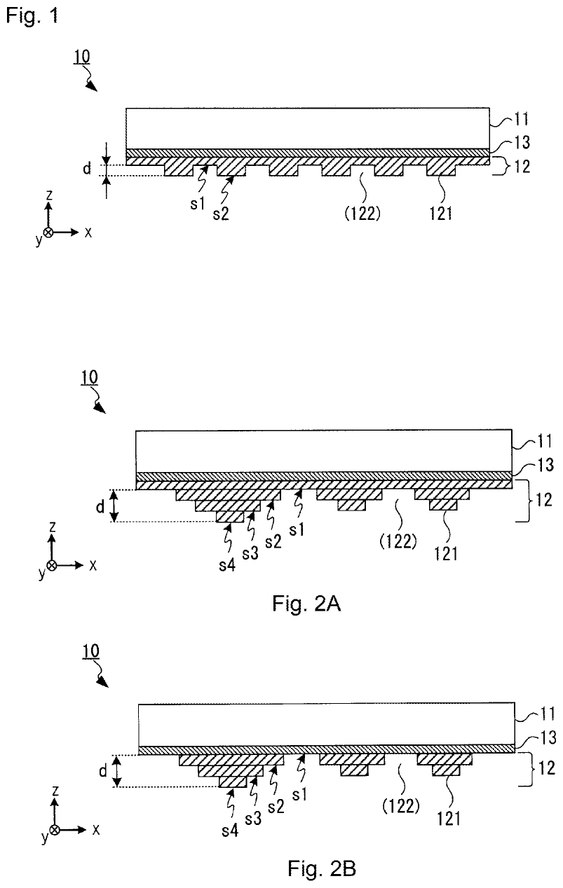

Now, the embodiment of the present invention will be described with reference to drawings. FIG. 1 is a schematic cross-sectional view of a diffractive optical element 10 in a first embodiment. The diffractive optical element 10 has a substrate 11, a convexo-concave portion 12 formed on one surface of the substrate 11 and an antireflection layer 13 formed between the substrate 11 and the convexo-concave portion 12. Hereinafter, the antireflection layer 13 formed between the substrate 11 and the convexo-concave portion 12 is referred to as “inner antireflection layer 13”.

The substrate 11 is not particularly restricted, so long as it is a member having a transparency to light having a wavelength to be used, and glass, a resin or the like may be mentioned. The wavelength to be used is a wavelength band of light which is incident on the diffractive optical element 10. The following description will be made with respect to light having a specific wavelength band (for example, 850 nm±20 nm) among visible light having a wavelength of from 700 to 1,200 nm and near infrared light, which is incident on the diffractive optical element 10, however, the wavelength to be used is not particularly restricted thereto. Further, unless otherwise specified, the visible range is a wavelength of from 400 nm to 780 nm, the infrared range is a wavelength of from 780 nm to 2,000 nm which is near infrared range, particularly from 800 nm to 1,000 nm, and ultraviolet range is a wavelength of from 300 nm to 400 nm which is near ultraviolet range, particularly from 360 nm to 380 nm. Here, visible light is light in the visible range, infrared light is light in the infrared range, and ultraviolet light is light in the ultraviolet range.

The convexo-concave portion 12 has a convexo-concave structure having a predetermined convexo-concave pattern having a function to diffract incident light. Specifically, the convexo-concave pattern is a two-dimensional pattern of steps formed by convex portions 121 of the convexo-concave portion 12 in planar view. Here, “planar view” is a plane viewed from a traveling direction of light entering the diffractive optical element 10 and corresponds to a plane viewed from a normal direction of the principal plane of the diffractive optical element 10. The convexo-concave pattern may be designed so that respective formed light spots of plural diffracted light rays can realize a predetermined light pattern on a predetermined projection plane or the like.

A convexo-concave pattern to form predetermined light spots forming a specific light pattern on a predetermined projection plane, is designed based on Fourier transformation of phase distribution of outgoing light.

In this embodiment, viewed from the convexo-concave portion 12, a direction approaching the substrate 11 is downward, and a direction away from the substrate 11 is upward. Accordingly, among the top surfaces of the respective steps of the convexo-concave portion 12, a surface closest to the substrate 11 is the undermost surface, and a surface farthest from the substrate 11 is the uppermost surface.

Further, in the following, a part at a higher position than a part at the lowest position (in Figs, the first step S1) in the convexo-concave pattern (a surface having a convexo-concave cross-section formed by the convexo-concave portion 12 on a surface of the substrate 11), is referred to as “convex portion 121”, and a part which is recessed portion surrounded by the convex portions 121 and is lower than the uppermost part (in this example, the second step s2) of the convex portions 121 is referred to as “concave portion 122”. Further, among the convexo-concave portion 12, the height of a part which actually generates phase difference, more specifically the distance from the first step s1 of the convexo-concave pattern to the uppermost part of the convex portion 121 is referred to as the height d of the convex portion 121 or the grating depth d. Further, in the following, a part which generates no phase difference in the convexo-concave portion 12 (a layer covering a surface of the substrate 11 and constituting the first step s1 in FIG. 1) may sometimes be referred to as “underlayer”.

Regarding the number of steps of the convexo-concave pattern, each plane constituting a step to generate phase difference with respect to incident light is counted as one step in the same manner as general diffraction gratings. Further, in FIG. 1, an example of a diffractive optical element 10 having a binary diffraction grating, namely a convexo-concave portion 12 constituting a two step convexo-concave pattern, is illustrated.

Another example of a diffractive optical element 10 is illustrated in FIGS. 2A and 2B. The diffractive optical element 10 may, for example, have a convexo-concave portion 12 constituting three or more step convexo-concave pattern as illustrating in FIG. 2A. Further, as illustrating in FIG. 2B, in the diffractive optical element 10, a member other than a member of the convexo-concave portion 12 (in this example, a member of the outermost layer of the after-mentioned inner antireflection layer 13) may constitute a first step of the convexo-concave pattern. Here, in such a case, the distance from the first step s1 of the convexo-concave pattern to the uppermost part of the convex portion 121 is the height d of the convex portion 121.

The structures illustrating in FIG. 1 and FIG. 2A are structures such that a second medium (air) constituting the concave portions 122 is not in contact with the inner antireflection layer 13 in at least the effective field where incident light enters. However, as illustrated in FIG. 2B, the diffractive optical element may have a structure such that a second medium (air) is in contact with the inner antireflection layer 13 in at least a part of the effective field. Here, in the latter case, the convexo-concave portion 12 has no underlayer.

As a material for the convexo-concave portion 12, one having a refractive index of at least 1.70 with respect to the wavelength to be used is used. As an example of such a material, an inorganic material such as an oxide, a nitride or an oxynitride of Zn, Al, Y, In, Cr, Si, Zr, Ce, Ta, W, Ti, Nd, Hf, Mg, La or Nb, a fluoride of Al, Y, Ce, Ca, Na, Nd, Ba, Mg, La or Li, a silicon carbide or a mixture thereof may be used. Further, a transparent conductor such as ITO may be used. Further, Si, Ge, diamond-like carbon or one having an impurity such as hydrogen incorporated therein may be used. Here, the material for the convexo-concave portion 12 is not restricted to the inorganic materials, so long as the refractive index with respect to light having the wavelength to be used satisfies the above condition. For example, as an example of a material containing an organic material and having a refractive index of at least 1.70, an organic material having fine particles of an inorganic material dispersed therein, so-called nano composite material, may be mentioned. As the fine particles of an inorganic material, an oxide of Zr, Ti, Al or the like may, for example, be mentioned.

Further, in a case where the concave portions 122 are filled with a medium other than air, Δn is at least 0.70, wherein Δn is the difference in the refractive index with respect to light having the wavelength to be used between the convex portions 121 and the concave portions 122. However, the concave portions 122 are preferably filled with air from the viewpoint of selectivity of the material and thickness reduction.

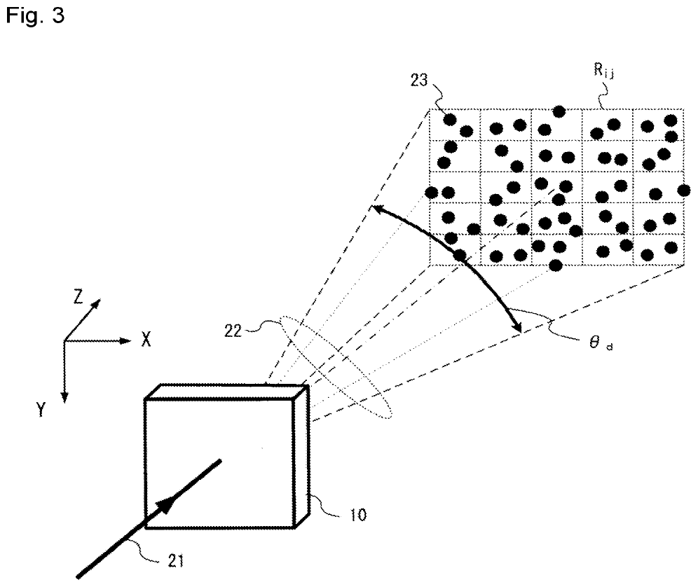

Now, the diffraction function caused by the diffractive optical element 10 will be described with reference to a light pattern formed by the diffractive optical element 10 illustrated in FIG. 3. The diffractive optical element 10 is formed so that outgoing diffracted light rays 22 will be two-dimensionally distributed, with respect to incident light 21 as light axis direction is Z-axis. In a case where X-axis and Y-axis have an intersection point with Z-axis and are perpendicular to Z-axis, the diffractive optical element 10 has a distribution of rays of incident light within an angle range of from the minimum angle θxₘᵢₙ to the maximum angle θxₘₐₓ on X-axis and from the minimum angle θyₘᵢₙ to the maximum angle θyₘₐₓ on Y-axis (they are not illustrated).

Here, X-axis is nearly parallel to a long side of a light spot pattern, and Y-axis is nearly parallel to a short side of the light spot pattern. Here, the range to be irradiated with diffracted light rays 22 of from the minimum angle θxₘᵢₙ to the maximum angle θxₘₐₓ in the X-axis direction and from the minimum angle θyₘᵢₙ to the maximum angle θyₘₐₓ in the Y-axis direction nearly corresponds to a light detection range by a light detection element to be used with the diffractive optical element 10. In this example, in the light spot pattern, a straight line parallel to Y-axis which passes a light spot having an angle of θxₘₐₓ in the X-direction to the Z-axis is the above short side, and a straight line parallel to X-axis which passes a light spot having an angle of θyₘₐₓ in the Y-direction to Z-axis is the above long side. Hereinafter, θ_{d} is an angle between an intersection point of the above short side and the above long side and the other intersection point at a diagonal position, and this angle is referred to as angle in a diagonal direction. Here, the angle θ_{d} in a diagonal direction (hereinafter referred to as “diagonal view angle θ_{d}”) is an emergent angle range θₒᵤₜ of the diffractive optical element 10. Here, the emergent angle range θₒᵤₜ is an angle range representing spread of a light pattern formed by diffracted light which is emergent from the convexo-concave portion 12, when incident light enters from a normal direction of the substrate 11. Further, the emergent angle range θₒᵤₜ of the diffractive optical element 10 may, for example, be the maximum value of an angle between two light spots included in diffracted light rays 22, other than the above-mentioned view angle θ_{d} in a diagonal direction.

For example, the diffractive optical element 10 preferably has an emergent angle range θₒᵤₜ when incident light enters from a normal direction of the surface of the substrate 11, of at least 70°. For example, some camera devices equipped in a smart phone, etc. have an angle of field (full angle) of about from 50 to 90°. Further, some LIDAR devices to be used for self-driving, etc. have a view angle of about from 30 to 70°. Further, human usually has a view angle of about 120°, and some camera devices such as a VR headset realize a view angle of from 70 to 140°. The diffractive optical element 10 may have the emergent angle range θₒᵤₜ of at least 100° or at least 120° so as to be used for such devices.

Further, the number of light spots to be formed by the diffractive optical element 10 may be at least 4, may be at least 9, may be at least 100 or may be at least 10,000. Further, the upper limit of the number of light spots is not particularly restricted, and may, for example, be 10,000,000 dots.

In FIG. 3, Rᵢⱼ represents a divided region of a projection plane. For example, in a case where a projection plane is divided into plural regions Rᵢⱼ, the diffractive optical element 10 may be designed so that the distribution density of light spots 23 of diffracted light rays 22 projected on each region Rᵢⱼ will be within ±50% to the average value of the entire regions. Here, the above distribution density may be within ±25% to the average value of the entire regions. The diffractive optical element 10 having such a structure is suitable in applications for measurement, etc., since the distribution of light spots 23 is made to be uniform on the projection plane. Here, the projection plane may be a curved plane as well as a flat plane. Further, the flat plane may be an inclined plane other than a plane which is perpendicular to a light axis of the optical system.

Each diffracted light included in diffracted light rays 22 illustrated in FIG. 3 is light diffracted at an angle θₓₒ in the X-direction and at angle θ_{yo} in the Y-direction on the basis of the Z-axis direction, in the diffraction grating equation represented by the equation (1). In the equation (1), mₓ is the diffraction order in the X-direction, m_{y} is the diffraction order in the Y-direction, A is a wavelength of incident light 21, Pₓ and P_{y} are pitches in the X-axis direction and the Y-axis direction of the after mentioned diffractive optical element, θₓᵢ is an incident angle to the diffractive optical element in the X-direction, and θ_{yi} is an incident angle to the diffractive optical element in the Y-direction. The diffracted light rays 22 are applied to a projection plane of a screen, an object to be measured or the like, whereby plural light spots 23 are formed in a projected region.

sin θₓₒ=sin θₓᵢ+mₓλ/Pₓ

sin θ_{yo}=sin θ_{yi}+m_{y}λ/P_{y} (1)

In a case where the convexo-concave portion 12 has a pseudo blaze shape in the form of stairs having N steps, and Δnd/λ=(N−1)/N is satisfied, the path difference formed by the convexo-concave portion 12 approximates a wave surface per one wavelength, whereby high diffraction efficiency can be obtained, such being preferred. For example, in a case where near infrared light is incident on a convexo-concave pattern having convex portions 121 made of a material having a refractive index of 1.7 and concave portions 122 filled with, {(N−1)/N}×λ=0.7d. Thus, it is preferred that the height d of the convex portions 121 satisfies d<{(N−1)/N}×λ/0.7.

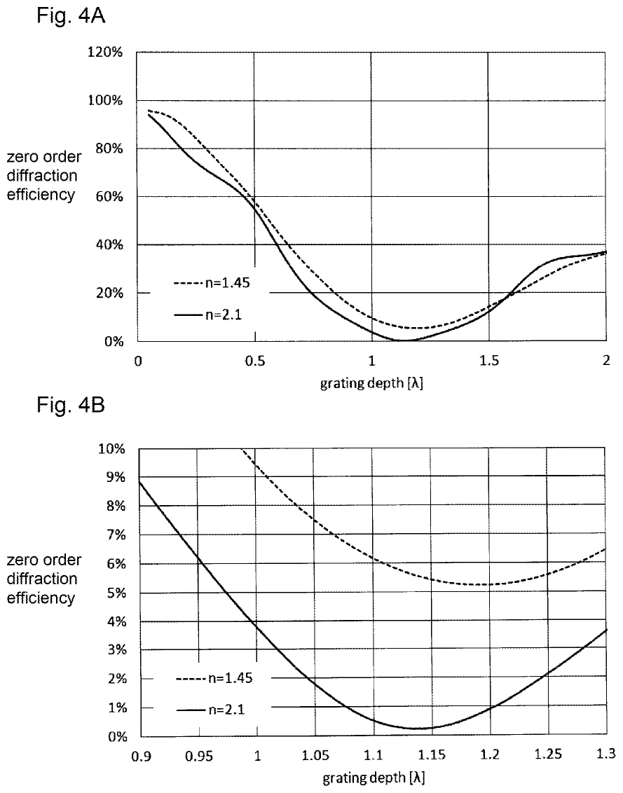

Further, each of FIGS. 4A and 4B is a graph showing the relation between the height (grating depth) d of the convex portions 121 and the intensity of zeroth order light. Further, FIG. 4A is a graph showing the relation between the grating depth of from 0.05λ to 2.0λ and the intensity of zeroth order light, and FIG. 4B is a graph showing a part of FIG. 4A enlarged. Each of FIGS. 4A and 4B is a design example in a case where 21 light spots in the X-direction and 21 light spots in the Y-direction, namely 441 light spots in total, are emitted in a range of NA0.85 (NA0.6 in the X-direction and the Y-direction) in a diagonal direction and exemplifies a case where a synthetic silica (refractive index n=1.45) is a material for the convex portions 121 and a case where Ta₂O₅ (n=2.1) is a material for the convex portions 121. Here, in this embodiment, NA is an index represented by 1·sin(θₘₐₓ/2).

As shown in FIGS. 4A and 4B, in a case where the refractive index is 1.45, zeroth order light will not be less than 5% in spite of any adjustment of the height d of the convex portions 121 due to the design of the structure realizing NA0.85 (the emergent angle range θₒᵤₜ of about 116°). On the other hand, when the refractive index is 2.1, the luminous energy of zeroth order light is suppressed to at most 1% or the like by adjusting the height d of the convex portions 121.

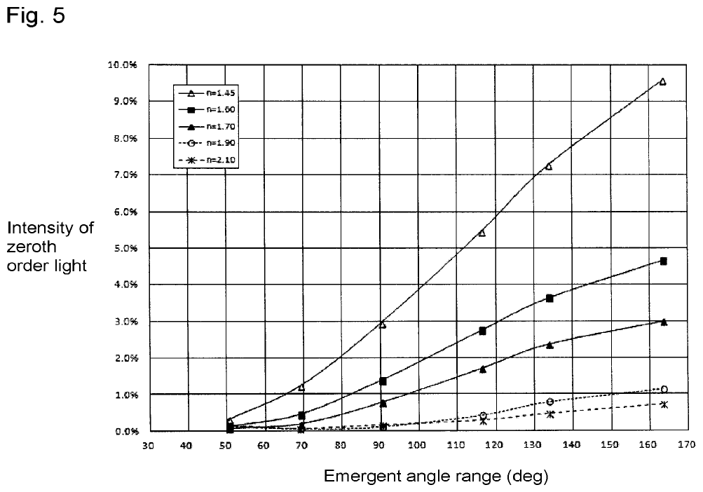

Here, it is preferred to satisfy Δn/NA≥0.7 for reducing zeroth order light while maintaining a high diffraction efficiency. Further, Δn/NA is preferably at least 0.7, more preferably at least 1.0. FIG. 5 is a graph showing the relation between the view angle θ_{d} in the diagonal direction and the intensity of zeroth order light (local minimum value of zeroth order light) with respect to five different refractive index materials as the material for the convex portions 121.

Here, the five different refractive index materials have a refractive index 1.45 (quartz), 1.60 (polycarbonate resin), 1.70 (SiON), 1.90 (HfO) and 2.10 (Ta₂O₅). FIG. 5 shows the intensity (local minimum value) of zeroth order light calculated by rigorous coupled-wave analysis (RCWA) with respect to design solutions when the view angle θ_{d} in a diagonal direction is 50.2°, 68.8°, 90.0°, 116.0°, 133.4° and 163.4° to the respective five refractive index materials. It is evident from FIG. 5 that the higher the refractive index of the convex portions 121 is, the higher the luminous energy of zeroth order light is. Further, if the view angle θ_{d} in a diagonal direction is represented by NA, they are 0.424, 0.565, 0.707, 0.848, 0.918 and 0.0989.

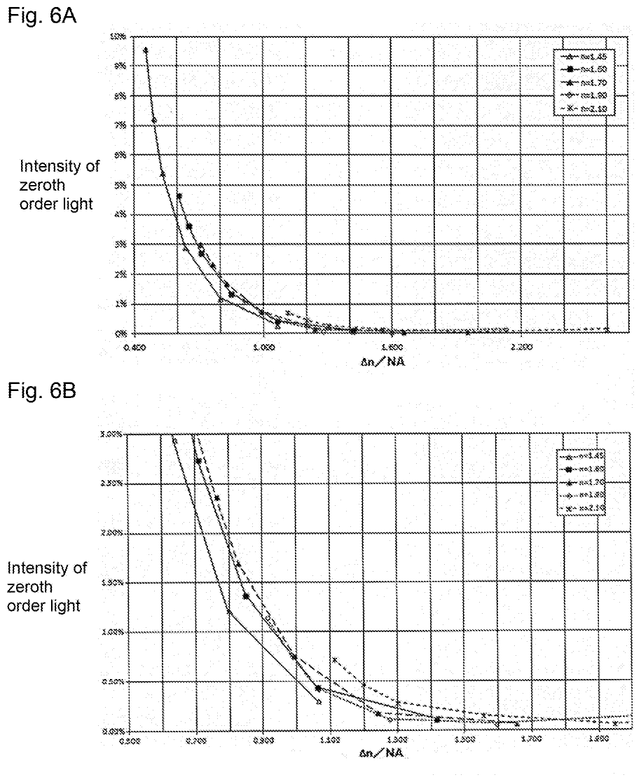

Further, FIGS. 6A and 6B show the relation between Δn/NA and the intensity (minimum value) of zeroth order light in the above-mentioned design solutions. Here, FIG. 6A is a graph showing all relations of the above-mentioned design solutions, and FIG. 6B is a graph showing a part of FIG. 6A enlarged.

In the above examples, the design wavelength is 850 nm, and concave portions are filled with air (n=1). Further, the convexo-concave portion 12 is a convexo-concave pattern having eight steps to form 21 light spots in the X-direction and 21 light spots in the Y-direction, namely 441 light spots in total, and in the convexo-concave pattern, gratings are regularly arranged, and all separation angles of adjacent light spots are equal. Table 1 shows design parameters of the respective examples.

TABLE 1

| | | Refractive | Emergent angle (total angle) | | | | | | Zeroth |
|---|---|---|---|---|---|---|---|---|---|
| | | index | [deg] | | | | | | order |
| | | Convex | X- | Y- | Diagonal | | | d | light |
| No. | | portion (n) | direction | direction | direction | NA | Δnd/λ | [μm] | [%] |
| 1 | 1 | 1.45 | 34.9 | 34.9 | 50.2 | 0.424 | 1.15 | 2.17 | 0.30 |
| | 2 | 1.45 | 47.1 | 47.1 | 68.8 | 0.565 | 1.15 | 2.17 | 1.22 |
| | 3 | 1.45 | 60.0 | 60.0 | 90.0 | 0.707 | 1.20 | 2.27 | 2.94 |
| | 4 | 1.45 | 73.7 | 73.7 | 116.0 | 0.848 | 1.20 | 2.27 | 5.44 |
| | 5 | 1.45 | 81.0 | 81.0 | 133.4 | 0.918 | 1.20 | 2.27 | 7.26 |
| | 6 | 1.45 | 88.8 | 88.8 | 163.4 | 0.989 | 1.20 | 2.27 | 9.60 |
| 2 | 1 | 1.60 | 34.9 | 34.9 | 50.2 | 0.424 | 1.15 | 1.63 | 0.12 |
| | 2 | 1.60 | 47.1 | 47.1 | 68.8 | 0.565 | 1.15 | 1.63 | 0.44 |
| | 3 | 1.60 | 60.0 | 60.0 | 90.0 | 0.707 | 1.15 | 1.63 | 1.37 |
| | 4 | 1.60 | 73.7 | 73.7 | 116.0 | 0.848 | 1.20 | 1.70 | 2.74 |
| | 5 | 1.60 | 81.0 | 81.0 | 133.4 | 0.918 | 1.20 | 1.70 | 3.63 |
| | 6 | 1.60 | 88.8 | 88.8 | 163.4 | 0.989 | 1.20 | 1.70 | 4.67 |
| 3 | 1 | 1.70 | 34.9 | 34.9 | 50.2 | 0.424 | 1.15 | 1.40 | 0.07 |
| | 2 | 1.70 | 47.1 | 47.1 | 68.8 | 0.565 | 1.15 | 1.40 | 0.18 |
| | 3 | 1.70 | 60.0 | 60.0 | 90.0 | 0.707 | 1.15 | 1.40 | 0.77 |
| | 4 | 1.70 | 73.7 | 73.7 | 116.0 | 0.848 | 1.15 | 1.40 | 1.71 |
| | 5 | 1.70 | 81.0 | 81.0 | 133.4 | 0.918 | 1.20 | 1.46 | 2.37 |
| | 6 | 1.70 | 88.8 | 88.8 | 163.4 | 0.989 | 1.20 | 1.46 | 3.00 |
| 4 | 1 | 1.90 | 34.9 | 34.9 | 50.2 | 0.424 | 1.10 | 1.04 | 0.15 |
| | 2 | 1.90 | 47.1 | 47.1 | 68.8 | 0.565 | 1.10 | 1.04 | 0.07 |
| | 3 | 1.90 | 60.0 | 60.0 | 90.0 | 0.707 | 1.15 | 1.09 | 0.12 |
| | 4 | 1.90 | 73.7 | 73.7 | 116.0 | 0.848 | 1.15 | 1.09 | 0.43 |
| | 5 | 1.90 | 81.0 | 81.0 | 133.4 | 0.918 | 1.15 | 1.09 | 0.79 |
| | 6 | 1.90 | 88.8 | 88.8 | 163.4 | 0.989 | 1.20 | 1.13 | 1.15 |
| 5 | 1 | 2.10 | 34.9 | 34.9 | 50.2 | 0.424 | 1.10 | 0.85 | 0.14 |
| | 2 | 2.10 | 47.1 | 47.1 | 68.8 | 0.565 | 1.10 | 0.85 | 0.06 |
| | 3 | 2.10 | 60.0 | 60.0 | 90.0 | 0.707 | 1.15 | 0.89 | 0.15 |
| | 4 | 2.10 | 73.7 | 73.7 | 116.0 | 0.848 | 1.15 | 0.89 | 0.28 |
| | 5 | 2.10 | 81.0 | 81.0 | 133.4 | 0.918 | 1.15 | 0.89 | 0.47 |
| | 6 | 2.10 | 88.8 | 88.8 | 163.4 | 0.989 | 1.15 | 0.89 | 0.72 |

It is evident from FIGS. 6A and 6B that regarding the relation between the intensity of zeroth order light and Δn/NA, for example, when Δn/NA is at least 0.7, the local minimum value of zeroth order light is less than 3.0% in all design solutions wherein the emergent angle range θₒᵤₜ is at least 70° (less than 165°). Further, for example, when Δn/NA is at least 0.9, the local minimum value of zeroth order light is less than 1.5% in many design solutions wherein the emergent angle range θₒᵤₜ is at least 100° (less than 165°). Further, for example, when Δn/NA is at least 1.0, the local minimum value of zeroth order light is less than 1.0% in many design solution wherein the emergent angle range θₒᵤₜ is less than 165°. Further, for example, when Δn/NA is at least 1.0, the local minimum value of zeroth order light is less than 0.5% in many design solutions wherein the emergent angle range θₒᵤₜ is less than 140°. Further, among design solutions shown in FIGS. 4A, 4B, 5, 6A and 6B, design solutions when n=1.45 and 1.60 are Comparative Examples.

Further, in the diffractive optical element 10 of this embodiment, the luminous energy of zeroth order light emerging from the diffractive optical element 10 when incident light perpendicularly enters is preferably less than 3.0%, more preferably less than 1.5%, further preferably less than 0.5%, particularly preferably less than 0.3%.

The inner antireflection layer 13 is formed to prevent interface reflection between the substrate 11 and the convexo-concave portion 12. The inner antireflection layer 13 is not particularly restricted, so long as it has an antireflection function to reduce reflectance to at least light having a design wavelength at an interface between the substrate 11 and the convexo-concave portion 12. A thin film having a monolayer structure or a multilayer film such as a dielectric multilayer film may, for example, be mentioned.

For example, an inner antireflection layer 13 being a monolayer thin film preferably satisfies the following conditional equation (2). Here, in the equation (2), nᵣ is a refractive index of a material for the inner antireflection layer, dᵣ is a thickness, nₘ is a refractive index of a medium to form an incident side interface of the inner antireflection layer to be an object, and n₀ is a refractive index of a medium to form an emergent side interface. In such a case, the reflectance at the interface can be lowered. Here, a is 0.25, and is 0.6. Hereinafter, the conditional equation represented by the equation (2) may sometimes be referred to as the first refractive index relation equation regarding the monolayer thin film. Further, α is more preferably 0.2, further preferably 0.1. Further, β is more preferably 0.4.

(nₒ×nₘ)^{0.5}−α<nᵣ<(n₀×nₘ)^{0.5}+α, and

(1−β)×λ/4<nᵣ×dᵣ<(1+β)×λ/4 (2)

Further, in a case where the inner antireflection layer 13 is a multilayer film, the reflectance R represented by the following equation (3) to light having a design wavelength is preferably less than 1%, more preferably less than less than 0.5%.

In a case where the inner antireflection layer 13 is a multilayer film, it is assumed that light enters a medium M1 being at an incident side with respect to the multilayer film and having a refractive index n₀ at an incident angle θ₀, transmits a multilayer film M2 comprising q layers each having a refractive index nᵣ and a thickness dᵣ and enters a medium M3 being at an emergent side with respect to the multilayer film and having a refractive index nₘ. Here, the reflectance is calculated by the equation (3). Further, η₀, ηₘ and ηᵣ are effective refractive indexes of the medium M1, the multilayer film M2 and the medium M3 respectively considering glazing incidence.

$$R = ( \frac{{η}_{0} - Y}{{η}_{0} + Y} ) {( \frac{{η}_{0} - Y}{{η}_{0} + Y} )}^{*} \\ here , \\ ( \begin{matrix}B \\ C\end{matrix} ) = \{ {\prod }_{r = 1}^{q} [ \begin{matrix}cos {δ}_{r} & ( i sin {δ}_{r} ) \text{/} {η}_{r} \\ i {η}_{r} sin {δ}_{r} & cos {δ}_{r}\end{matrix} ] \} [ \begin{matrix}1 \\ {η}_{m}\end{matrix} ] \\ Y = C \text{/} B \\ {η}_{0} = \frac{{n}_{0}}{cos {θ}_{0}} ( when p polarization ) , {η}_{0} = {n}_{0} * cos {θ}_{0} ( when s polarization ) \\ {η}_{m} = \frac{{n}_{m}}{cos {θ}_{m}} ( when p polarization ) , {η}_{m} = {n}_{m} * cos {θ}_{m} ( when s polarization ) \\ {η}_{r} = \frac{{n}_{r}}{cos {θ}_{r}} ( when p polarization ) , {η}_{r} = {n}_{r} * cos {θ}_{r} ( when s polarization ) \\ {δ}_{r} = 2 π {n}_{r} {d}_{r} cos {θ}_{r} \text{/} λ \\ {n}_{0} * sin {θ}_{o} = {n}_{m} * sin {θ}_{m} = {n}_{r} * sin {θ}_{r} \qquad ( 3 )$$

Accordingly, if the inner antireflection layer 13 is not formed, Y=ηₘ, and relatively large reflection results, while if Y is made to be close to η₀ by the inner antireflection layer 13, reflection can be reduced. Particularly, in the case of normal incidence, ηₒ, ηₘ and ηᵣ are equivalent to refractive indexes. Hereinafter, the reflectance R represented by the equation (3) may sometimes be referred to as a theoretical reflectance of the multilayer structure.

In general, a member constituting the convexo-concave portion 12 is a thin film, and it is necessary to calculate the reflectance as a part of the above multilayer film. However, as described above, by forming the inner antireflection layer 13, the reflectance can be lowered independent of the thickness of the thin film constituting the convexo-concave portion 12. Further, in the case of the monolayer inner antireflection layer 13, the equation (3) wherein q=1 may be applied, and the effect of the interference may be considered.

Further, in a case where inclined light (wavelength: λ [nm]) enters the inner antireflection layer 13, the following condition is preferably satisfied, when light vertically enters. That is, the transmittance spectrum within a range of from λ-200 nm to λ+200 nm has a local minimum value within a range of from λ to λ+200 nm. The minimum value more preferably falls within a range of from λ to λ+100 nm. When inclined light enters, the transmittance spectrum blue-shifts, whereby the decrease of the transmittance at an interface of the inner antireflection layer 13 due to inclined incidence can be suppressed. Further, λ corresponds to “design wavelength”.

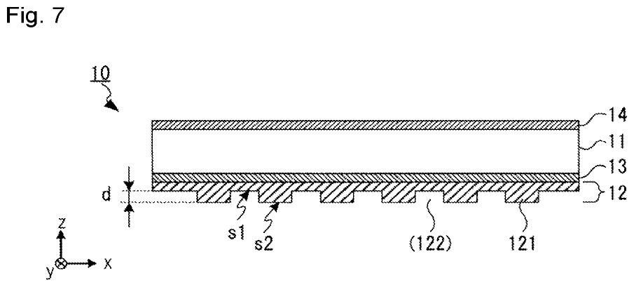

Further, as illustrated in FIG. 7, the diffractive optical element 10 may further have an antireflection layer 14 on a surface of the substrate 11 opposite from the surface provided with the convexo-concave portion 12.

The antireflection layer 14 is formed to prevent reflection at an emergent side interface of the diffractive optical element 10. The antireflection layer 14 is not particularly restricted, so long as it has an antireflection function to reduce reflectance to at least light having a design wavelength at the emergent side interface of the diffractive optical element 10. A monolayer structure thin film and a multilayer film such as a dielectric multilayer film may, for example, be mentioned. Here, the conditions regarding the reflectance of the inner antireflection layer 13 may be applied as the conditions regarding the reflectance of the antireflection layer 14 as they are.

Further, in a case where light is incident on the diffractive optical element 10 from a side (z-direction in figure) provided with the convexo-concave portion 12, the inner antireflection layer 13 and the antireflection layer 14 preferably satisfy the above-mentioned reflectance to light having a design wavelength and being incident within θₘₐₓ/2° to the normal direction of the substrate 11. In such a case, light diffracted by the convexo-concave portion 12 is incident on the inner antireflection layer 13 and the antireflection layer 14. Further, the inner antireflection layer 13 and the antireflection layer 14 may satisfy the above conditions regarding the reflectance to specific polarized light having the design wavelength and being incident within θₘₐₓ/2° to the normal direction of the substrate 11.

For example, the inner antireflection layer 13 and the antireflection layer 14 are constructed so that the reflectance to at least specific polarized light having the design wavelength and being incident within 40° to the normal direction of the substrate 11 will be at most 0.5%. Further, the inner antireflection layer 13 and the antireflection layer 14 may be constructed so that the reflectance to light emerging from the diffractive optical element 10 at an angle of ¼ of the emergent angle range θₒᵤₜ, namely at a half angle of the maximum emergent angle (half angle), will be at most 0.5%.

Further, the inner antireflection layer 13 and the antireflection layer 14 may have an antireflection function to light in a specific wavelength band (for example ultraviolet light) other than the design wavelength, in addition to the antireflection function to light having a design wavelength, because a device or the like which is provided with the diffractive optical element 10 may sometimes have an optical element other than the diffractive optical element 10, and the diffractive optical element 10 should not shield light used for such another optical element.

In such a case, in addition to the above conditions for light having a design wavelength, the inner antireflection layer 13 and the antireflection layer 14 may be constructed so that the reflectance to at least specific polarized light having a wavelength of from 360 to 370 nm and being incident within 20° to the normal direction of the substrate 11, will be at most 1.0%.

Further, in the above, the luminous energy of zeroth order light is calculated by RCWA, however, the luminous energy of zeroth order light may also be evaluated by measuring the luminous energy of straight transmitted light when collimated laser light having a design wavelength is incident on the diffractive optical element 10.

### EXAMPLES

### Ex. 1

This example is an example of the diffractive optical element 10 illustrated in FIGS. 2A and 2B. Here, in this example, the design wavelength is 850 nm, and the concave portions are filled in air (n=1). Further, the convexo-concave portion 12 is a convexo-concave pattern having 8 steps to form 21 light spots in a X-direction and 21 light spots in a Y-direction, namely 441 light spots in total, and gratings are regularly arranged in the convexo-concave pattern, and all separation angles of adjacent light spots are equal. Further, in the diffractive optical element 10 of this example, the convexo-concave pattern is designed so that the emergent angle range θₒᵤₜ (more specifically, diagonal view angle θ_{d}) of diffracted light rays which are emergent from the convexo-concave portion 12 will be 110°. Further, a glass substrate having a refractive index of 1.51 was used as a material for the substrate 11, and Ta₂O₅ having a refractive index of 2.19 was used as a material for the convexo-concave portion 12. Table 2 shows a specific structure of the convexo-concave portion 12 of this example.

TABLE 2

| | | | Refractive | Thickness |
|---|---|---|---|---|
| Structure | | Material | index | [nm] |
| Anti reflection layer | | SiO₂ | 1.45 | 172 |
| | | Ta₂O₅ | 2.19 | 67 |
| | | SiO₂ | 1.45 | 42 |
| | | Ta₂O₅ | 2.19 | 18 |
| | | SiO₂ | 1.45 | 35 |
| | | Ta₂O₅ | 2.19 | 18 |
| Substrate | | Borosilicate glass | 1.51 | — |
| Inner antireflection layer | | Ta₂O₅ | 2.19 | 19 |
| | | SiO₂ | 1.45 | 34 |
| | | Ta₂O₅ | 2.19 | 25 |
| | | SiO₂ | 1.45 | 26 |
| Convexo- | Convex portion | Ta₂O₅ | 2.19 | 665 |
| concave | Under layer | Ta₂O₅ | 2.19 | 435 |
| portion | | | | |

First, an antireflection layer 14 which is a dielectric multilayer film having 6 layers made of SiO₂ or Ta₂O₅ is film-formed on a glass substrate. Table 2 shows a material and a thickness of each layer.

Then, an inner antireflection layer 13 which is a dielectric multilayer film having 4 layers made of SiO₂ and Ta₂O₅ is film-formed on a surface of the glass substrate opposite form the side having the antireflection layer 14 formed. Table 2 shows a material and a thickness of each layer. Then, Ta₂O₅ which is a material for the convexo-concave portion 12 is film-formed, and the Ta₂O₅ film is processed into a convexo-concave structure having 8 steps by photolithography and etching. In this convexo-concave structure, the height of one step is 95 nm. The film thickness is measured by a step profiler or cross-section observation by SEM (scanning electron microscope).

In such a manner, the diffractive optical element 10 of this example is obtained.

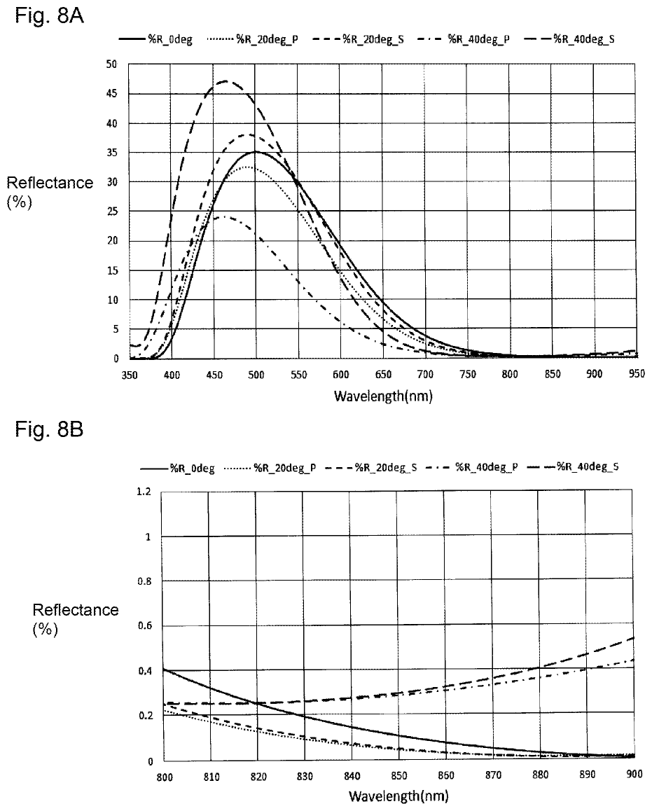

FIGS. 8A and 8B show results of calculation of the reflectance of the antireflection layer 14 of this example. Here, FIG. 8A shows results of calculation of the reflectance in a wavelength range of from 350 nm to 950 nm, and FIG. 8B shows results of calculation of the reflectance in a wavelength range of from 800 nm to 900 nm among the above wavelength. Further, FIGS. 8A and 8B show results of calculation in a case where the incident angle, namely an angle of incident light to the normal direction of the substrate 11, is 0°, 20° and 40°. Inclined incidence is divided into P polarization and S polarization.

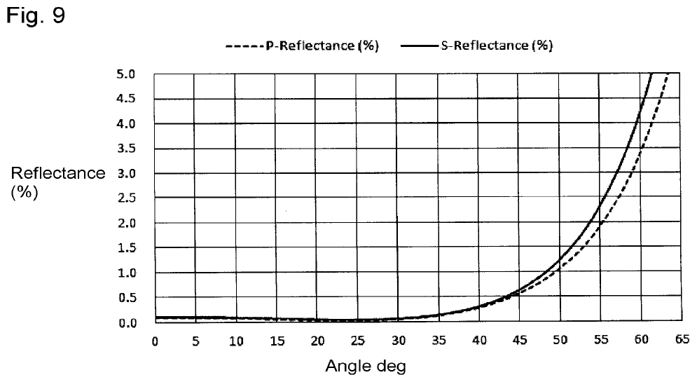

Further, FIG. 9 shows the incident angle dependence of the reflectance of the antireflection layer 14 of this example to light having a wavelength of 850 nm. As shown in FIG. 9, the antireflection layer 14 of this example has a reflectance of less than 2.5% to light having a wavelength of 850 nm and being incident within an incident angle of 55° in both P polarization and S polarization. Further, the antireflection layer 14 of this example has a reflectance of less than 1.0% to P polarized light having a wavelength of 850 m and being incident within the incident angle of 45°.

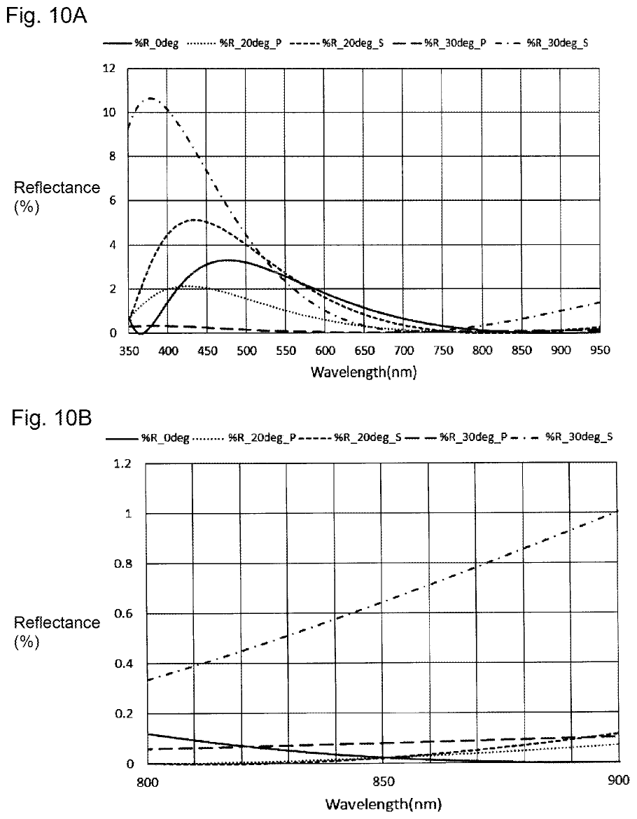

Further, FIGS. 10A and 10B show results of calculation of the reflectance of the inner antireflection layer 13 in this example. Here, FIG. 10A shows results of calculation of the reflectance in a wavelength range of from 350 nm to 950 nm, and FIG. 10B shows results of calculation of the reflectance in a wavelength range of from 800 nm to 900 nm among the above wavelength. Further, FIGS. 10A and 10B show results of calculation in a case where the incident angle, namely the incident angle to the normal direction of the substrate 11, is 0°, 20° and 30°.

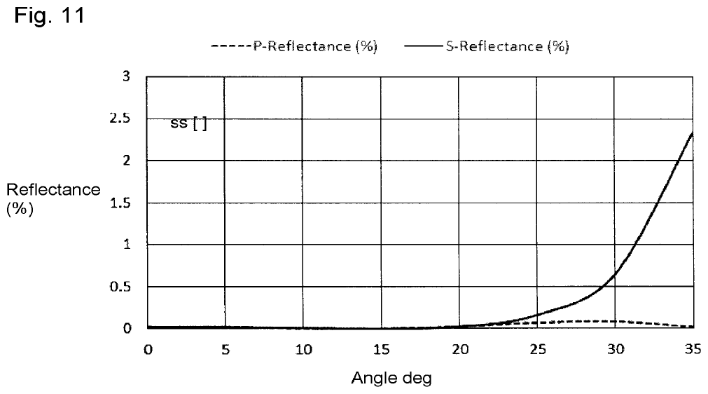

Further, FIG. 11 shows the incident angle dependence of the reflectance of the inner antireflection layer 13 in this example to light having a wavelength of 850 nm. As shown in FIG. 11, the inner antireflection layer 13 in this example has a reflectance of less than 2.5% to light having a wavelength of 850 nm and being incident at an incident angle within 35° in both P polarization and S polarization. Further, the antireflection layer 14 in this example has a reflectance of less than 0.1% to P polarized light having a wavelength of 850 nm and being incident at an incident angle within 35°. Further, the reflectances of the inner antireflection layer 13 and the antireflection layer 14 to light at an incident angle of higher than 35° are omitted, however, they can be calculated by means of the above equation (3) with effective refractive indexes of respective mediums depending on the incident angle.

Further, the luminous energy of zeroth order light emerging from the convexo-concave portion 12 of the diffractive optical element 10 in this example was calculated by RCWA, and it was 0.25%. Accordingly, under assumption of no loss due to reflection and absorption at the incident side interface and in the diffractive optical element, the luminous energy of zeroth order light emerging from the diffractive optical element in this example when light having a wavelength of 850 nm perpendicularly enters, is less than 0.22%.

### Ex. 2

This example is an example of the diffractive optical element 10 illustrated in FIGS. 2A and 2B similarly to Ex. 1. However, in this example; the convexo-concave portion 12 is a convexo-concave pattern having 8 steps to form 11 light spots in a X-direction and 11 light spots in a Y-direction, namely 121 light spots in total. The specific structure of the convexo-concave portion 12 in this example is the same as in Ex. 1 and shown in Table 2. Further, the production method is also the same as in Ex. 1.

Further, the luminous energy of zeroth order light emerging from the convexo-concave portion 12 of the diffractive optical element 10 in this example was calculated by RCWA, and it was 0.08%. Accordingly, under assumption of no loss due to reflection and absorption at the incident side interface and in the diffractive optical element, the luminous energy of zeroth order light emerging from the diffractive optical element in this example when light having a wavelength of 850 nm perpendicularly enters, is less than 0.07%.

### Ex. 3

This example is an example of the diffractive optical element 10 illustrated in FIGS. 2A and 2B similarly to Ex. 1. However, in this example; the convexo-concave portion 12 is a convexo-concave pattern having 8 steps to form 31 light spots in a X-direction and 31 light spots in a Y-direction, namely 961 light spots in total. The specific structure of the convexo-concave portion 12 in this example is the same as in Ex. 1 and shown in Table 2. Further, the production method is also the same as in Ex. 1.

Further, the luminous energy of zeroth order light emerging from the convexo-concave portion 12 of the diffractive optical element 10 in this example was calculated by RCWA, and it was 0.08%. Accordingly, under assumption of no loss due to reflection and absorption at the incident side interface and in the diffractive optical element, the luminous energy of zeroth order light emerging from the diffractive optical element in this example when light having a wavelength of 850 nm perpendicularly enters, is less than 0.07%.

### Ex. 4

This example is an example of the diffractive optical element 10 illustrated in FIGS. 2A and 2B similarly to Ex. 1. However, in this example, the design wavelength is 780 nm, and the convexo-concave portion 12 is a convexo-concave pattern having 8 steps to form 21 light spots in a X-direction and 21 light spots in a Y-direction, namely 441 light spots in total. The specific structure of the convexo-concave portion 12 in this example is the same as in Ex. 1 and shown in Table 3. Further, the production method is also the same as in Ex. 1.

Further, the luminous energy of zeroth order light emerging from the convexo-concave portion 12 of the diffractive optical element 10 in this example was calculated by RCWA, and it was 0.32%. Accordingly, under assumption of no loss due to reflection and absorption at the incident side interface and in the diffractive optical element, the luminous energy of zeroth order light emerging from the diffractive optical element in this example when light having a wavelength of 780 nm perpendicularly enters, is less than 0.28%.

TABLE 3

| | | | Refractive | Thickness |
|---|---|---|---|---|
| Structure | | Material | index | [nm] |
| | | SiO₂ | 1.46 | 103 |
| | | Ta₂O₅ | 2.20 | 11 |
| Anti reflection laver | | SiO₂ | 1.46 | 46 |
| | | Ta₂O₅ | 2.20 | 236 |
| | | SiO₂ | 1.46 | 250 |
| | | Ta₂O₅ | 2.20 | 156 |
| Substrate | | Borosilicate glass | 1.52 | — |
| | | Ta₂O₅ | 2.20 | 17 |
| Inner antireflection layer | | SiO₂ | 1.46 | 38 |
| | | Ta₂O₅ | 2.20 | 27 |
| | | SiO₂ | 1.46 | 24 |
| Convexo- | Convex portion | Ta₂O₅ | 2.20 | 569 |
| concave | Under layer | Ta₂O₅ | 2.20 | 100 |
| portion | | | | |

### Ex. 5

This example is an example of the diffractive optical element 10 illustrated in FIGS. 2A and 2B similarly to Ex. 1. However, in this example, the design wavelength is 1550 nm, and the convexo-concave portion 12 is a convexo-concave pattern having 8 steps to form 21 light spots in a X-direction and 21 light spots in a Y-direction, namely 441 light spots in total. The specific structure of the convexo-concave portion 12 in this example is the same as in Ex. 1 and shown in Table 4. Further, the production method is also the same as in Ex. 1.

Further, the luminous energy of zeroth order light emerging from the convexo-concave portion 12 of the diffractive optical element 10 in this example was calculated by RCWA, and it was 0.03%. Accordingly, under assumption of no loss due to reflection and absorption at the incident side interface and in the diffractive optical element, the luminous energy of zeroth order light emerging from the diffractive optical element in this example when light having a wavelength of 780 nm perpendicularly enters, is less than 0.03%.

TABLE 4

| | | | Refractive | Thickness |
|---|---|---|---|---|
| Structure | | Material | index | [nm] |
| Antireflection layer | | SiO₂ | 1.44 | 229 |
| | | Ta₂O₅ | 2.17 | 7 |
| | | SiO₂ | 1.44 | 173 |
| | | Ta₂O₅ | 2.17 | 75 |
| | | SiO₂ | 1.44 | 241 |
| | | Ta₂O₅ | 2.17 | 383 |
| Substrate | | Borosilicate glass | 1.52 | — |
| Inner antireflection layer | | Ta₂O₅ | 2.17 | 75 |
| | | SiO₂ | 1.44 | 46 |
| | | Ta₂O₅ | 2.17 | 12 |
| | | SiO₂ | 1.44 | 35 |
| Convexo- | Convex portion | Ta₂O₅ | 2.17 | 1159 |
| concave | Under layer | Ta₂O₅ | 2.17 | 100 |
| portion | | | | |

### INDUSTRIAL APPLICABILITY

The present invention is suitably used in applications for broadening the range in which a predetermined light pattern formed by a diffraction grating is applied, while reducing zeroth order light.

This application is a continuation of PCT Application No. PCT/JP2018/039755, filed on Oct. 25, 2018, which is based upon and claims the benefit of priority from Japanese Patent Application No. 2017-215510 filed on Nov. 8, 2017. The contents of those applications are incorporated herein by reference in their entireties.

### REFERENCE SYMBOLS

10: diffractive optical element
11: substrate
12: convexo-concave portion
121: convex portion
122: concave portion
13: inner antireflection layer
14: antireflection layer
21: incident light
22: diffracted light rays
23: light spot

What is claimed is:

1. A diffractive optical element which comprises
a substrate,
a convexo-concave portion formed on one surface of the substrate and having a predetermined diffraction function to incident light, and
an antireflection layer formed between the substrate and the convexo-concave portion,
wherein the difference in the refractive index in a wavelength band of the incident light between a first medium constituting convex portions of the convexo-concave portion and a second medium constituting concave portions of the convexo-concave portion is at least 0.70, and
when the incident light enters from a normal direction of the substrate, an emergent angle range which is an angle range representing spread of a light pattern formed by the diffracted light emerging from the convexo-concave portion, is at least 60°.

2. The diffractive optical element according to claim 1, wherein the second medium is air, and the first medium has a refractive index of at least 1.70 in the wavelength band of the incident light.

3. The diffractive optical element according to claim 1, which satisfies Δn/sin(θₒᵤₜ/2)≥1.0, wherein Δn is a difference in the refractive index in the wavelength band of the incident light between the first medium and the second medium, and θₒᵤₜ is the emergent angle range.

4. The diffractive optical element according to claim 1, wherein zeroth order light in the wavelength band of the incident light has a luminous energy of less than 3.0%.

5. The diffractive optical element according to claim 1, wherein the emergent angle range is at least 100°, and zeroth order light in the wavelength band of the incident light has a luminous energy of less than 1.5%.

6. The diffractive optical element according to claim 1, wherein the emergent angle range is less than 140°, and zeroth order light in the wavelength band of the incident light has a luminous energy of less than 0.5%.

7. The diffractive optical element according to claim 1, wherein the first medium is an inorganic material.

8. The diffractive optical element according to claim 1, wherein the convexo-concave portion is not in contact with the substrate at least in the effective field.

9. The diffractive optical element according to claim 1, wherein the antireflection layer is a dielectric multilayer film and has a reflectance of at most 0.5% to at least specific polarized light in the wavelength band of the incident light emerging from the element at an angle of ¼ of the emergent angle range to the normal direction of the substrate.

10. The diffractive optical element according to claim 1, wherein the antireflection layer has a reflectance of at most 0.5% to at least specific polarized light in the wavelength band of the incident light which enters the antireflection layer within 40° to the normal direction of the substrate.

11. The diffractive optical element according to claim 1, wherein the incident light is light in a wavelength band of at least a part of from 700 nm to 1,200 nm, and the antireflection layer has a reflectance of at most 1.0% to at least specific polarized light having a wavelength of from 360 to 370 nm which enters the antireflection layer within 20° to the normal direction of the substrate.

12. The diffractive optical element according to claim 1, which has a second antireflection layer on a surface of the substrate opposite from the side provided with the convexo-concave portion.

13. The diffractive optical element according to claim 12, wherein the second antireflection layer has a reflectance of at most 0.5% to at least specific polarized light in the wavelength band of the incident light emerging from the element at an angle of ¼ of the emergent angle range to the normal direction of the substrate.
